(19) United States
(12) Patent Application Publication
(10) Pub. No.: US 2006/0227480 A1
(43) Pub. Date: Oct. 12, 2006

(54) Voltage providing circuit

(75) Inventors: Hai-Qing Zhou, Shenzhen (CN); Yong-Xing You, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/322,872

(22) Filed: Dec. 30, 2005

(30) Foreign Application Priority Data
Apr. 8, 2005 (CN) 200510034113.4

(51) Int. Cl. H02H 5/04

(52) U.S. Cl. 361/103

(57) ABSTRACT

A voltage providing circuit for a central processing unit (CPU) includes a power supply, three voltage regulation modules, and a pulse width modulation (PWM) controller. The power supply provides three voltages respectively to the three voltage regulation modules. The PWM controller outputs three signals to the three voltage regulation modules. The three voltage regulation modules regulate the voltages from the power supply according to the signals from the PWM controller, and output a regulated voltage to the CPU. The voltage providing circuit also includes three resettable fuses, which are respectively connected between the three voltage regulation modules and the power supply. The resettable fuses automatically shut off the voltage providing circuit when a current is overloading the circuit and turn on the voltage providing circuit when the current is normal.

### BACKGROUND OF THE INVENTION

1. Field of the Invention

The present invention relates to a voltage providing circuit for a central processing unit (CPU), and particularly to a voltage providing circuit which can prevent damage to the CPU from a current overload.

2. General Background

A CPU is one of the most important parts in a computer system, which includes a controlling unit, a logic unit, and a storage unit.

A voltage providing circuit for a CPU in a computer motherboard may be single-phase, two-phase, or three-phase. The three-phase voltage providing circuit can provide three times of the current of the single-phase voltage providing circuit. As computer technology develops, voltage requirements for CPU's are getting larger and larger, so the single-phase and the two-phase voltage providing circuit cannot satisfy the voltage requirement of the modern CPU. Currently, most of computer motherboards adopt the three-phase voltage providing circuit.

Referring to FIG. 3, a conventional three-phase voltage providing circuit for a CPU 6 includes a power supply 1, a first voltage regulation module 2, a second voltage regulation module 3, a third voltage regulation module 4, and a Pulse Width Modulation (PWM) controller 5. The power supply 1 provides three voltages respectively to the first voltage regulation module 2, the second voltage regulation module 3, and the third voltage regulation module 4. The PWM controller 5 outputs three pulse signals respectively to the first voltage regulation module 2, the second voltage regulation module 3, and the third voltage regulation module 4, in order to control these voltage regulation modules to regulate the three voltages from the power supply 1. A voltage regulated by these voltage regulation modules is provided for the CPU 6.

The conventional three-phase voltage providing circuit provides enough current for the CPU 6. However, the CPU 6 is often destroyed by a current overload, which may be caused by an instantaneous change of a load or other factors.

What is needed is a voltage providing circuit which provides enough current for the CPU and also effectively prevent the CPU from being damaged due to a current overload.

### SUMMARY

A voltage providing circuit for a CPU in accordance with a preferred embodiment includes a power supply, three voltage regulation modules, and a PWM controller. The power supply provides three voltages respectively to the three voltage regulation modules. The PWM controller outputs three signals to the three voltage regulation modules. The three voltage regulation modules regulate the voltages from the power supply according to signals from the PWM controller, and output a regulated voltage to the CPU. The voltage providing circuit also includes three resettable fuses, which are respectively connected between the three voltage regulation modules and the power supply. The resettable fuses automatically shut off the voltage providing circuit when a current is too high and turn on the voltage providing circuit when the current is normal.

Other objects, advantages and novel features will become more apparent from the following detailed description when taken in conjunction with the accompanying drawings, in which:

### BRIEF DESCRIPTION OF THE DRAWINGS

FIG. 1 is a block diagram of a voltage providing circuit for a CPU, in accordance with a preferred embodiment of the present invention;

FIG. 2 is a circuit diagram of the voltage providing circuit of FIG. 1; and

FIG. 3 is a block diagram of a conventional voltage providing circuit for a CPU.

### DETAILED DESCRIPTION OF THE EMBODIMENT

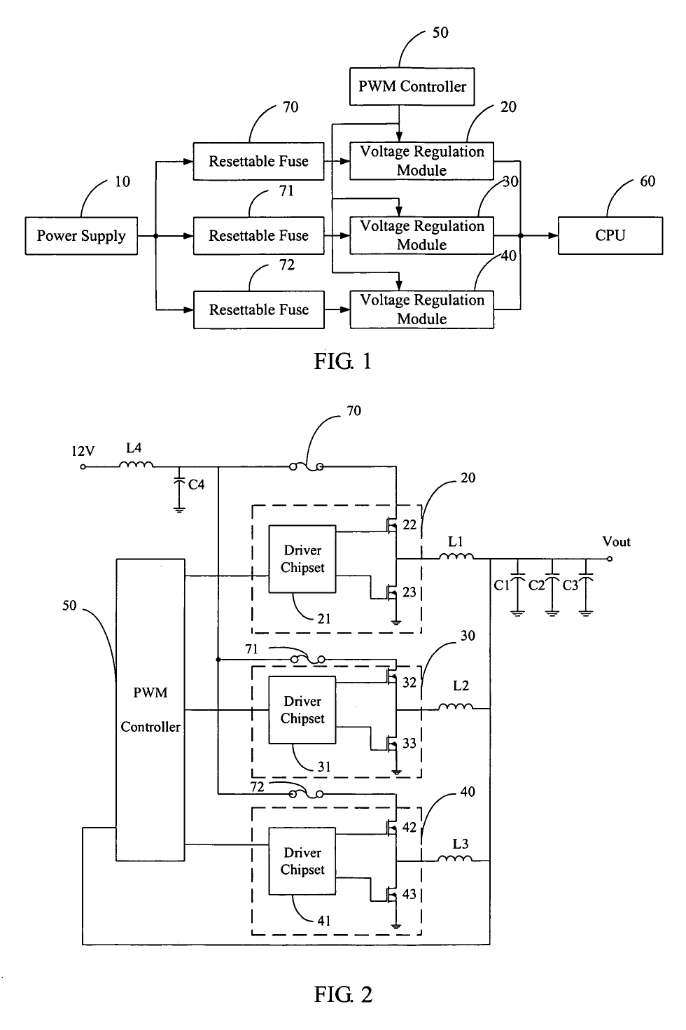

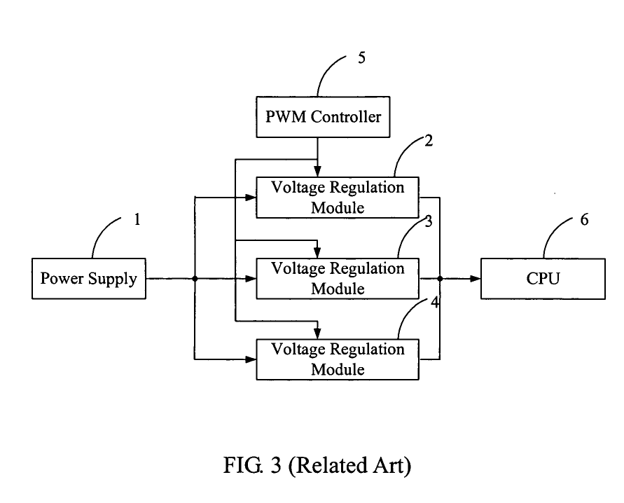

Referring to FIG. 1, a voltage providing circuit for a CPU 60 for an electronic component like a CPU of a preferred embodiment of the present invention is shown. The voltage providing circuit includes a power supply 10, a PWM controller 50, a first voltage regulation module 20, a second voltage regulation module 30, a third voltage regulation module 40, a first resettable fuse 70, a second resettable fuse 71, and a third resettable fuse 72, wherein the PWM controller 50 and all voltage regulation modules together form a control means to control voltage providing of the CPU 60. The resettable fuses 70, 71, and 72 are respectively connected between the power supply 10 and the first voltage regulation module 20, the second voltage regulation module 30, and the third voltage regulation module 40. The PWM controller 50 is connected to the voltage regulation modules 20, 30, and 40.

Referring to FIG. 2, the first voltage regulation module 20 includes a driver chipset 21, a first Metal Oxide Semiconductor Field-Effect Transistor (MOSFET) 22, and a second MOSFET 23. The second voltage regulation module 30 includes a driver chipset 31, a first MOSFET 32, and a second MOSFET 33. The third voltage regulation module 40 includes a driver chipset 41, a first MOSFET 42, and a second MOSFET 43. The driver chipset 21 respectively provides two pulse signals to gates of the first MOSFET 22 and the second MOSFET 23. A source of the first MOSFET 22 is connected to a drain of the second MOSFET 23 and a source of the second MOSFET 23 is grounded. The driver chipset 31 respectively provides two pulse signals to gates of the first MOSFET 32 and the second MOSFET 33. A source of the first MOSFET 32 is connected to a drain of the second MOSFET 33, and a source of the second MOSFET 33 is grounded. The driver chipset 41 respectively provides two pulse signals to gates of the first MOSFET 42 and the second MOSFET 43. A source of the first MOSFET 42 is connected to a drain of the second MOSFET 43 and a source of the second MOSFET 43 is grounded. An input terminal Vin is connected to drains of the MOSFETS 22, 32, and 42 respectively via the resettable fuses 70, 71, and 72. An inductance L4 and a ground capacitance C4 are connected to the input terminal Vin. Three signal terminals of the PWM controller 50 respectively are connected to the driver chipsets 21, 31, and 41. A node between the source of the first MOSFET 22 and the drain of the second MOSFET 23 is connected to an output terminal Vout via an inductance L1. A node between the source of the first MOSFET 32 and the drain of the second MOSFET 33 is connected to an output terminal Vout via an inductance L2. A node between the source of the first MOSFET 42 and the drain of the second MOSFET 43 is connected to an output terminal Vout via an inductance L3. Three capacitances C1, C2, and C3 are connected to the output terminal Vout. The output terminal Vout is coupled to the PWM controller.

When a current of the voltage providing circuit is normal, the resettable fuses 70, 71, and 72 are turned on. The power supply 10 provides three starting voltages respectively to the MOSFETS 22, 32, and 42. The starting voltage is commutated and filtered by the inductance L4 and the ground capacitance C4. The PWM controller 50 provides three pulse signals to start the driver chipsets 21, 31, and 41. Each of the driver chipsets 21, 31, and 41 provides two pulse signals with different phase positions respectively to the first MOSFETs 22, 32, and 42 and the second MOSFETs 23, 33, and 43. When the first MOSFETs 22, 32, 42 are turned on and the second MOSFETs 23, 33, 43 are turned off, energy is stored in the inductances L1, L2, L3; When the second MOSFETs 23, 33, 43 are turned on and the first MOSFETs 22, 32, 42 are turned off, the energy is released from the inductances L1, L2, L3. Then three voltages from the nodes are filtered by the ground capacitors C1, C2 and C3 and are output to the CPU 60. The three voltages output to the CPU 60 are feedback to the PWM controller 50.

When the current of the voltage providing circuit is over loading, the resettable fuses 70, 71, and 72 are turned off. Thus, the power supply 10 is disconnected to the MOSFETS 22, 32, and 42 turning them off. So the voltage providing circuit is shut off and the CPU 60 will not be damaged by an overloading current.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

We claim:

1. A voltage providing circuit for a central processing unit (CPU), the voltage providing circuit comprising:
a power supply;
a voltage regulation module for regulating a voltage from the power supply;
a pulse width modulation (PWM) controller for starting the voltage regulation module; and
a resettable fuse connected between the power supply and the voltage regulation module for protecting the CPU from damage.

2. The voltage providing circuit as claimed in claim 1, wherein the regulation module comprises:
a driver chipset started by a pulse signal from the PWM controller;
a first Metal Oxide Semiconductor Field-Effect Transistor (MOSFET) comprising a gate connected to the driver chipset, a drain connected to the power supply via the resettable fuse and a source; and
a second MOSFET comprising a gate connected to the driver chipset, a drain connected to the source of the first MOSFET and a source grounded.

3. The voltage providing circuit as claimed in claim 2, wherein an inductance and a ground capacitor are connected to a node between the first MOSFET and the second MOSFET for commutating and filtering a voltage output to the CPU.

4. The voltage providing circuit as claimed in claim 3, wherein the voltage output to the CPU is feedback to the PWM controller.

5. The voltage providing circuit as claimed in claim 1, wherein an inductance and a ground capacitance are connected to the power supply to commutate and filter the voltage from the power supply.

6. A voltage providing circuit for a central processing unit (CPU) comprising:
a power supply;
a first transistor comprising a first end connected to the power supply, a second end, and a third end;
a second transistor comprising a first end connected to the third end of the first transistor, a second end, and a third end grounded;
a driver chipset connected to the second end of the first transistor and the second end of the second transistor, for controlling the first transistor and the second transistor to be turned on or turned off;
a pulse width modulation (PWM) controller connected to the driver chipset for staring the driver chipset;
a resettable fuse connected between the power supply and the first end of the first transistor; and
a node between the third end of the first transistor and the first end of the second transistor connected to the CPU.

7. The voltage providing circuit as claimed in claim 6, wherein an inductance and a ground capacitor are connected to the node between the first transistor and the second transistor for commutating and filtering a voltage output to the CPU.

8. The voltage providing circuit as claimed in claim 6, wherein the voltage outputted to the CPU is feedback to the PWM controller.

9. The voltage providing circuit as claimed in claim 6, wherein an inductance and a ground capacitance are connected to the power supply to commutate and filter a voltage from the power supply.

10. A circuit for controlling power supply to an electronic component, comprising:
a power supply capable of powering an electronic component;
a control means electrically connectable between said power supply and said electronic component for controlling said powering of said power supply to said electronic component; and
a resettable fuse electrically connectable between said power supply and said control means so as to protect said electronic component from over-current-loading damage by means of shutting down said powering of said power supply through said control means when a over-current-loading status is sensed by said resettable fuse.

11. The circuit as claimed in claim 10, wherein said control means comprises a pulse width modulation (PWM) controller and at least one voltage regulation module for regulating voltage output of said power supply.
